(19) United States
(12) Patent Application Publication
(10) Pub. No.: US 2025/0350125 A1
(43) Pub. Date: Nov. 13, 2025

(54) ELECTROLYSIS PLANT AND PLANT NETWORK COMPRISING AN ELECTROLYSIS PLANT AND A RENEWABLE ENERGY PLANT

(71) Applicant: Siemens Energy Global GmbH & Co. KG, Erlangen (DE)

(72) Inventor: Sven Schumann, Wilhermsdorf (DE)

(21) Appl. No.: 18/862,630

(22) PCT Filed: Jan. 20, 2023
(86) PCT No.: PCT/EP2023/051412

§ 371 Date: Nov. 4, 2024

(30) Foreign Application Priority Data
May 4, 2022 (DE) 10 2022 204 401.0

(51) Int. Cl. H02J 3/38; C25B 9/65

(52) U.S. Cl. CPC H02J 3/381; C25B 9/65; H02J 2300/24

(57) ABSTRACT

An electrolysis plant includes an electrolyzer and a circuit assembly, which has an input for connecting to a power source and an output connected to the electrolyzer. The circuit assembly has an electrical filter unit which is designed in such a way that high-frequency signal components, in particular from the external power source, can be very effectively damped. There is also described a plant network with an electrolysis plant and a renewable energy plant. A power source with an output is formed by the renewable energy plant and the electrolysis plant is directly connected to the output of the renewable energy plant.

The invention relates to an electrolysis plant comprising an electrolyzer and a circuit arrangement. The invention further relates to a plant network comprising an electrolysis plant and a renewable energy plant connected to the electrolysis plant.

An electrolysis plant is an apparatus that brings about a conversion of substances with the aid of electrical current (electrolysis). In accordance with the variety of different electrochemical electrolysis processes, there are also a multiplicity of electrolysis plants, for example an electrolysis plant for water electrolysis.

Hydrogen is nowadays produced, for example, from water by means of Proton Exchange Membrane (PEM) electrolysis or alkaline electrolysis. The electrolysis plants produce hydrogen and oxygen from the supplied water with the aid of electrical energy. This process takes place in an electrolysis stack composed of a plurality of electrolysis cells. In the electrolysis stack that is under a DC voltage, water is introduced as the educt, wherein, after passing through the electrolysis cells, two fluid flows consisting of water and gas bubbles (O₂ or H₂) emerge.

Current considerations include producing valuable substances using excess energy from renewable energy sources in times when there is a lot of sun and a lot of wind, that is to say above-average solar power or wind power production. A valuable substance may be, in particular, hydrogen which is produced by water electrolysis plants. So-called renewable energy gas-also referred to as RE gas—can be produced on the basis of hydrogen, for example. An RE gas is a combustible gas which is obtained from renewable sources with the aid of electrical energy.

Hydrogen is a particularly environmentally friendly and sustainable energy carrier. It has the unique potential to implement energy systems, traffic and large parts of the chemical industry without CO₂ emissions. However, to achieve this, the hydrogen must not come from fossil sources, but rather must be produced with the aid of renewable energy.

In the meantime, at least a growing proportion of the power produced from renewable sources has been fed into the public power grid. Therefore, according to the power mix, a corresponding proportion of green hydrogen can be produced if an electrolysis plant is operated with power from the public grid.

In the case of electrolysis processes carried out on an industrial scale, the direct current is predominantly provided via line-commutated rectifiers. During this rectification of a grid-side AC voltage, the method of operation of the rectifiers may result in harmonics which can load the AC grid and/or the DC grid.

EP 3 723 254 A1 discloses such an electrolysis plant that is connected to the public power grid and is accordingly fed with grid power. For this purpose, the electrolysis plant has a circuit arrangement comprising four coil arrangements and four rectifiers. The first coils of the coil arrangements are each connected to the DC voltage side of one of the rectifiers. The circuit arrangement also comprises two transformers, each having a primary winding and two secondary windings. The primary windings of the transformers are connected to the power grid, for example a medium-voltage grid or a high-voltage grid. This makes it possible to carry out desired smoothing of the direct current, or the attenuation of the harmonics, despite the reduced iron content within the first coil.

A source of renewable energies results from the increasing use of wind power. In particular, so-called offshore wind energy plants can be used to achieve high electrical powers. However, the challenge is that it is necessary to overcome a large distance to the consumers. The energy should therefore be transported to the consumer with as little loss as possible. Hydrogen is very suitable as a transport medium and energy carrier. It can be transported through pipelines in gaseous form, for example. A positive secondary aspect here is that a hydrogen-carrying pipeline can perform the function of an energy storage device at the same time since the internal pressure can be varied within certain limits.

From these considerations, it is of particular economic interest to produce the hydrogen directly at the energy production location, that is to say autonomously and independently of the public grid. For this purpose, it is proposed to install the electrolysis plants on offshore platforms in the maritime sector directly at offshore wind energy plants or in the immediate vicinity of the latter and to electrically supply them with the power produced.

Concepts for using the power from onshore wind power plants or photovoltaic plants to directly produce hydrogen at least partially by means of a direct connection to and feeding into an electrolysis plant have also been proposed for dry land. In all of these applications, the electrolysis plant is part of an island grid. The electrolysis current is therefore not obtained from the public grid, but rather is supplied directly by a wind energy plant or a PV plant and is fed into an electrolyzer of the electrolysis plant. In contrast to the line-commutated operation described above, this respectively entails special challenges and problems in terms of the electrotechnical attachment and connection of the electrolysis plant to the respective RE production plant, whether a wind energy plant or a photovoltaic plant, in particular in order to ensure safe and, in particular, interference-free operation of the electrolysis plant in a direct plant network having the RE production plant.

The invention is therefore based on the object of specifying an electrolysis plant that can be used to feed power from a renewable source into the electrolysis plant directly and without interference.

This object is achieved, according to the invention, by means of an electrolysis plant comprising an electrolyzer and a circuit arrangement having an input for connection to a power source and an output connected to the electrolyzer, wherein the circuit arrangement has an electrical filter device which is designed in such a way that high-frequency signal components can be attenuated.

The invention is already based on the knowledge that electrolysis plants, in particular the PEM water electrolysis cells of the electrolyzer, are very sensitive to high-frequency electrical stray currents. These stray currents can be coupled into the electrolysis plant via ground connections or ground faults. As a result of necessary plant 17 parts such as process engineering, gas separators, auxiliary systems, water-carrying supply lines etc. of an electrolysis plant, the connection to ground is insufficient on the electrolysis side (ground fault or ground loop). It is therefore important, on the one hand, to prevent current paths from being able to be closed via ground, that is to say to prevent a ground fault or ground loop from being formed. On the other hand, it is necessary to prevent, if possible, the coupling-in of electromagnetic interference fields per se or at least to reduce the interference. This problem is particularly pronounced when an electrolysis plant is directly connected to a DC source which is provided, for instance, by a photovoltaic plant or a wind energy plant.

The disadvantageous effects of a ground loop and the coupling of alternating electromagnetic fields into the power electronic components used scale accordingly in this complex plant network consisting of a renewable energy production plant and an electrolysis plant with direct RE feeding-in of the electrolysis current for the purpose of operating the electrolysis. For example, the widespread and preferred use of insulated-gate bipolar transistors (IGBT for short) is in the rectifier supplying the electrolysis with high current. An IGBT can generate relatively strong interference signals particularly on the ground side. The IGBT is a semiconductor component that is used in power electronics since it combines advantages of the bipolar transistor, such as a good on-state behavior, a high reverse voltage and robustness, and the advantages of a field effect transistor by means of virtually power-free control. As a result, very accurate control of the electrolysis current with good rectification is achieved, for instance, in a so-called three-phase B6 bridge circuit with an IGBT-based rectifier. The distinctive advantages of IGBTs are the high voltage and current limits: voltages of up to 6500 V and currents of up to 3600 A with a power of up to a few megawatts, which predestines IGBTs for use in electrolysis plants.

Using the invention, a filter device is provided on the DC side in an electrolysis plant having the circuit arrangement so as to achieve effective filtering of interference signals as a result of high-frequency electrical stray currents between the external power supply source and the DC-operated electrolyzer. It has proven advantageous for flexible coupling and direct connection to different power sources that the filter-based circuit arrangement is an integral component of the electrolysis plant itself. As a result, a wide range of connection options are inherently provided and grid-independent operation, in particular island operation, is particularly advantageously possible. In this case, the original power source or power supply source may be both a DC source and an AC source and this is advantageously provided directly from renewable energies. The filter device achieves a particularly interference-free supply of a stable direct current to the electrolyzer in both settings and applications. The filter device provides a particularly simple solution that is flexibly adjustable. In this case, systems and components of the separate supply of the electrolysis plant, that is to say the auxiliary systems, the controller, etc., can also advantageously be connected downstream of the filter on the plant side and can be used to operate said systems and components since high-quality direct current is already provided there. Using the invention, in particular it is possible to attenuate high-frequency signal components from an external power source itself to which the electrolysis plant can be connected in order to be supplied with an electrolysis current. However, filtering of high-frequency signal components from other power sources of the electrolysis plant itself with interference or in the surroundings thereof can also lead to coupling-in with interference.

In the circuit arrangement, the filter device advantageously acts in terms of its mode of operation in a similar manner to a grid filter and can accordingly be designed in a manner specifically adapted to application in an electrolysis plant. In the present case, the filter device may thus be in the form of an electrical circuit, for example, that both limits electrical interference originating from electrical devices and components in the electrolysis plant having the electrolyzer into the power source (radio interference suppression) and significantly improves the electromagnetic compatibility and the protection of the electrolysis plant with respect to interference from the feeding power source. The latter leads to an increase in the interference immunity of the electrolysis plant. This is of particular interest and particularly advantageous in applications in which the current is to be fed into the electrolysis plant as direct current directly and without interference from a renewable source, that is to say in the case of a direct infeed or DC infeed from a renewable energy plant.

In the circuit arrangement, the filter device may optionally be in the form of a low-pass filter and comprise inductances and capacitors. The area of application in an electrolysis plant for direct connection and supplying electrolysis current to an electrolyzer is preferably the medium-voltage and low-voltage range, depending on the power source. The filter device is advantageously integrated as a component of the circuit arrangement directly into the electrolysis plant that is particularly sensitive to interfering stray currents or possibly into current-carrying parts of the plant that cause interference. It is possible and advantageous here that the circuit arrangement having the filter device is in the form of a separate module that can be connected and integrated into the electrolysis plant. A filtered and interference-free DC voltage is thus ensured, and specifically at a voltage or current level that is desired and predetermined for the electrolysis.

The circuit arrangement is therefore particularly advantageously configured as a filter device and is designed to provide direct current by means of an external power source, in particular an external DC source, for the purpose of supplying the electrolyzer with electrolysis current. This is carried out by directly coupling or directly connecting the input to an external power source, in particular directly to an external DC source. As the external DC source, a wind energy plant or a photovoltaic plant can advantageously be connected to the electrolysis plant and can each be advantageously configured both for offshore applications and for onshore applications in a manner independent of the grid in so-called island operation.

In advantageous applications with an available external DC source as power source, said source can be connected directly via the input of the circuit arrangement such that interference-free DC supply of the electrolyzer is achieved. Filtering and decoupling by means of the filter device provided in the circuit arrangement reliably prevents damaging scattering of high-frequency stray currents and thus ground fault currents and undesirable voltage losses in the sensitive electrolyzer, particularly coupling-in into the electrolysis cells. Safe operation of the electrolysis plant with a high degree of reliability and improved service life is achieved since losses resulting from voltage-reducing current paths are reduced. At the same time, it is possible to achieve simple and reliable direct connection of the electrolysis plant to an energy production plant based on renewable energies and a desired grid-independent operation is possible.

In a particularly preferred configuration, the filter device has a low-pass filter.

A low-pass filter is used to provide an implementation that can be particularly easily integrated into the circuit arrangement for suppressing or filtering out the high-frequency interference frequencies from the power source and for connecting only the desired direct current for the electrolysis. The low-pass filter may in this case be in the form of a passive analog low-pass filter that for example has a resistor, a coil and a capacitor or has several of these electrical components. Using additional active components, such as operational amplifiers or transistors, it is also possible that an active analog low-pass filter is provided in the filter device. In the case of digital signal processing that may be required, time-discrete low-pass filters are implemented in filter structures such as the FIR or IIR filter. This is done using digital circuits such as FPGAs or by means of sequential computer programs.

Low-pass filters for high powers for high frequency and the electrical energy technology-as preferred in the present case for the electrolysis plant-are made of capacitors and coils. They are generally found at the load outputs of frequency converters, class D amplifiers, switched-mode power supplies and in grid filters.

In a preferred configuration of the electrolysis plant, the filter device is in the form of a low-pass filter of the 1^{st} order which has an RC element.

In the simplest case, the low-pass filter advantageously consists of a resistor/capacitor combination, what is known as an RC element, and constitutes a Butterworth filter of the first order. In the function-describing model, it is provided that the source impedance of the input voltage of the filter is zero and the load impedance in the output voltage of the filter is infinitely high.

In an RC element, a possibly sudden change in the input voltage is followed by the output voltage by the same step size but with a delay over the course of an exponential function with a time constant τ=RC, the so-called transfer function of the RC element.

In a particularly simple configuration, as an alternative or in addition, a simple coil or coil arrangement for attenuating primarily the high-frequency signal components is also conceivable. Said coil or coil arrangement is connected for example directly between a rectifier and the electrolyzer and during operation carries the full load current, that is to say it is thus not connected to ground but instead to the rectifier and the electrolyzer.

The filter device preferably has an inductance that attenuates the high frequency components.

In another preferred configuration of the electrolysis plant, the filter device is in the form of a low-pass filter of the 2^{nd} order or a higher order which has at least one LRC low-pass filter. It is thus possible to achieve a power source with particularly effective filtering and interference suppression for direct DC connection of the power source to the electrolysis plant.

A low-pass filter of the second order is advantageously obtained for the circuit arrangement by virtue of an inductance L being connected in series with a resistor R, since the reactance Xi thereof is also dependent on frequency—and specifically in the opposite direction to the capacitor reactance X^{c}. R is thus selected to be so great that there is no excessive increase in voltage or only a low increase in voltage of the frequency response.

By connecting multiple low-passive filters in the circuit arrangement one behind the other, it is also possible to advantageously increase the order thereof. For example, two low-pass filters of the 2nd order that are connected one behind the other form a low-pass filter of the 4^{th} order. The attenuation changes above the cut-off frequency with 4×20 dB/decade=80 dB/decade, which corresponds to an edge steepness of 24 db/octave. However, two interconnected low-pass filters with the same cut-off frequency do not result in a low-pass filter of a higher order with the same cut-off frequency. To dimension a low-pass filter with a desired cut-off frequency, there are respective formulae and tables available that can be applied to the external power source depending on the connection situation of the electrolysis plant. In addition, the problem of a low-pass filter in a chain being influenced by the output resistance of the upstream low-pass filter and the input resistance of the downstream low-pass filter may arise. This effect can be counteracted using impedance converters that are additionally integrated into the circuit arrangement as required. In general, n storing elements, that is to say capacitors or coils, can be provided for a low-pass filter of the nth order. The attenuation of a low-pass filter of the nth order increases above the cut-off frequency by n·20 dB/decade. Furthermore, it is preferably possible to use a plurality of parallel filters, in particular low-pass filters, and to interconnect same advantageously in combination to form a filter arrangement in the electrolysis plant. The respective filters are in this case set to different frequencies or frequency ranges that they are each intended to suppress.

In a preferred configuration of the electrolysis plant, the filter device is in the form of an active filter, wherein the filter device has an operational amplifier.

Operational amplifiers can advantageously be used to implement active low-pass filters in the filter device. They have the advantage that the frequency response remains the same even when a load is connected to the output. They can thus also be dimensioned such that they also only minimally load the power source so that it may have an impedance greater than zero.

In a particularly preferred configuration of the electrolysis plant, it comprises a rectifier, the output side of which is connected to the input of the circuit arrangement and the input side of which is connected to an external AC source such that a direct current without high-frequency signal components can be supplied to the electrolyzer via the filter device. A direct current free of high-frequency signal components contains and comprises from a technical point of view here a direct current substantially or mostly free of high-frequency signal components.

The electrolysis plant is thus particularly advantageously equipped and set up for direct connection to an AC source, such as for connection to a wind energy plant whose generator supplies alternating current. The inverter is connected to the circuit arrangement on the DC voltage side, that is to say at the output of the inverter. The inverter can be connected to an external AC source on the AC side, that is to say at the input of the inverter. The interconnection of the inverter with the circuit arrangement provides an interference-suppressed connection of the electrolysis plant to an AC source for the operation of the electrolysis plant. In this application, it is also possible that the inverter is already an integral component of the circuit arrangement. The circuit arrangement then has the inverter and the filter device for an AC connection of the electrolysis plant and these components both interact advantageously. As a result, the electrolysis plant is tailored for a direct connection directly on the AC side to an AC source, such as a wind energy plant in island operation. In this case, the electrolysis plant is located in close proximity to the wind energy plant or is integrated into the wind farm having a plurality of wind energy plants.

The rectifier is preferably controllable and/or in the form of a three-phase rectifier, in particular the rectifier is in the form of a B6 bridge rectifier.

The ability to control the rectifier or rectifiers that is or are advantageously in the form of a three-phase rectifier or a B6 bridge rectifier makes it possible to adjust the total current generated by the rectifier or rectifiers and thus to precisely control for example the operation of an electrolyzer that is connected to the circuit arrangement.

In this case, in a preferred configuration of the electrolysis plant, a filter device is connected in series between the rectifier and the electrolyzer. The series circuit in terms of the rectification system and electrolyzer constitutes a possible and advantageous arrangement of the filter device. The electrolyzer is thus protected from interfering instances of coupling-in of high-frequency stray currents, for example via ground loops. In this arrangement, the load current is fully carried by the filter device.

In an alternatively or additionally preferred configuration of the electrolysis plant, a filter device is connected to the rectifier, wherein the filter device is connected to a reference-ground potential, in particular to ground potential or ground. Consequently, the load current does not have to be carried by the filter device. This alternative configuration results in a solution that is particularly expedient in terms of costs.

In this configuration, the filter device is connected by way of its input side directly to the DC side, that is to say the output of the rectifier, and a second connection is connected to the ground potential. The output of the rectifier is connected at the same time to the electrolyzer, such that the output of the rectifier, the input of the filter device and the DC supply line to the electrolyzer are at the same potential.

It is also possible in principle and advantageous in certain applications that the series interconnection of the filter device described above is combined with the alternative interconnection via ground potential in the circuit arrangement. However, a respective configuration and selection of one of the two circuit variants is generally preferred since this is less complex and costly in execution.

A further aspect of the invention results from the configuration of the electrolysis plant for a preferred electrical connection of the electrolysis plant to an external power source, in particular to an external DC source, wherein a renewable energy plant is directly electrically connected to the electrolysis plant. This produces an integral plant network.

In a particularly preferred configuration, the plant network comprises an electrolysis plant and a renewable energy plant, wherein the renewable energy plant forms a power source having an output, and wherein the electrolysis plant is connected to the output of the renewable energy plant.

As a result, island network operation that is independent of the public grid is possible in the plant network and immediate use of power exclusively from renewable sources for the electrolysis such that green hydrogen is formed.

In the plant network, the renewable energy plant preferably has a wind energy plant.

It is also possible that, in the plant network, the renewable energy plant is a wind energy plant or a wind farm having a plurality of wind energy plants. In this case, an electrolysis plant can also be supplied with alternating current from multiple wind energy plants interconnected on the AC side. The wind-based generation of 100% renewable green power is particularly attractive in combination with the electrolysis. The rectifier in the electrolysis plant, the output side of which is connected to the input of the circuit arrangement or which is electrically connected to the input thereof, is used to achieve filtering and interference suppression. In this case, the rectifier converts the alternating current from the wind energy plant into a direct current and simultaneously advantageously provides the desired DC voltage level at the input for operation of the electrolyzer. At the same time, a direct connection to the wind energy plant and an integrated plant network is achieved.

This also advantageously makes it possible to be able to filter a plurality of electrically parallel-connected electrolyzers of an electrolysis plant. It is possible to perform filtering in the electrolysis plant both once centrally downstream of the rectifier or directly at the plurality of parallel-connected electrolyzers using a plurality of smaller appropriately designed filter devices that can then be connected and disconnected in order to vary a partial load. Particularly when the electrolysis process of an electrolyzer is stopped, said electrolyzer is particularly susceptible to high-frequency stray currents caused by the operation of the parallel-connected electrolyzers or plant units of the electrolysis plant.

In an alternative or additional configuration of the plant network, it is preferred that an electrolysis plant is connected to a renewable energy plant, wherein the renewable energy plant has a photovoltaic plant, such that a DC source having an output is formed, and wherein the electrolysis plant is connected to the output of the photovoltaic plant.

In an alternative configuration, it is also preferably possible and preferred that the renewable energy plant in the plant network is a photovoltaic plant. During operation, a PV plant already provides a direct current that can easily be used for the electrolysis.

With respect to the renewable energy plant, combined plants are also possible in the plant network, these having both a wind energy plant and a photovoltaic plant. In a PV plant rectification is not required-in contrast, a wind energy plant generally initially generates and provides an alternating current. A rectifier is therefore required in the plant network having a wind energy plant for electrolysis purposes. Said rectifier is preferably already a constituent part of the electrolysis plant that is accordingly configured for operation in a wind energy plant. However, a rectifier may also already be provided in the wind energy plant itself in order to provide direct current at the connection or transition point to the electrolysis plant.

For configuration as a combined plant, it may furthermore be preferred to connect a battery or another energy storage device in parallel with a wind energy plant and/or a photovoltaic plant in a plant network and to integrate same into the plant network. The battery or the energy storage device is preferably then also connected to a DC/DC converter in an analogous manner to an electrical connection of a photovoltaic plant.

It is thus possible to provide a direct connection of a battery or an energy storage device, with the supply and charging of the battery or the energy storage device then preferably being provided by a power source. As an extension to the renewable energy plant (RE plant), the battery or the energy storage device is expedient and very advantageous, even for load control and uniform energization of the electrolysis plant with power from the battery and primarily as a buffer store in low-wind and/or low-sunlight weather conditions.

In the case of a photovoltaic plant, provision is preferably made in the plant network for the photovoltaic plant to have a DC chopper or DC voltage converter that forms the output.

In this case, the output of the DC chopper forms a DC source of the photovoltaic plant at a predefinable DC voltage level. The electrolysis plant is connected directly to the output of the photovoltaic plant. It is also conceivable and possible that the DC chopper is a component of the power electronics system of the electrolysis plant and is adapted accordingly to the PV voltage level.

A DC voltage converter, also referred to as DC-DC converter, denotes an electrical circuit that converts a DC voltage supplied at the input to a DC voltage with a higher, lower or inverted voltage level. The conversion is performed using a periodically operating electronic switch and one or more energy storage devices. DC voltage converters are included in self-commutated power converters. In the field of electrical engineering, they are also referred to as DC choppers. The inductance (inductive converter) used to buffer-store the energy consists of a coil or a converter transformer.

Advantages and advantageous configurations of the electrolysis plant of the invention are to be considered as advantages and advantageous configurations of the plant network and vice versa.

Further advantages, features and details of the invention emerge from the following description of a preferred exemplary embodiment and on the basis of the drawing. The features and combinations of features mentioned above in the description and the features and combinations of features mentioned below in the description of the figures and/or shown in the single figures alone can be used not only in the respectively stated combination, but also in other combinations or alone, without departing from the scope of the invention.

Exemplary embodiments of the invention are explained in more detail on the basis of a drawing, in which, in a schematic and highly simplified manner:

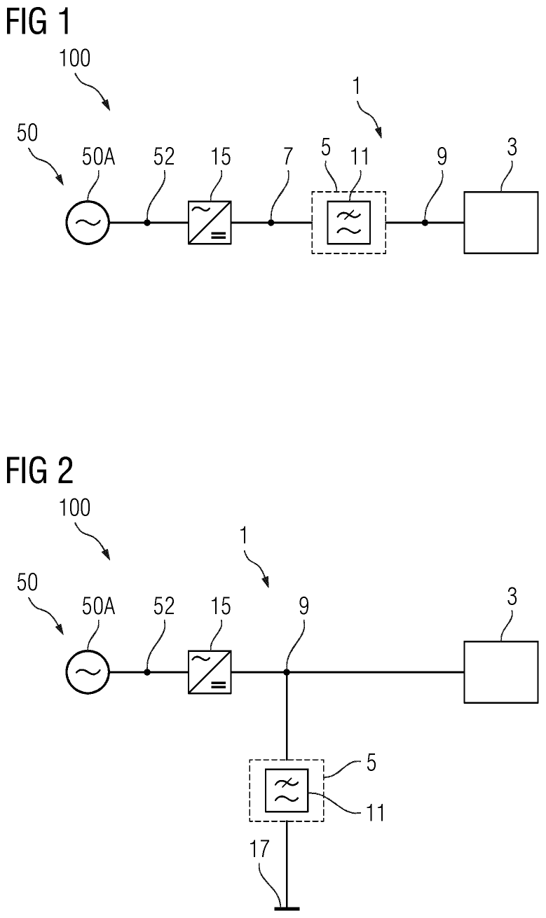

FIG. 1 shows a plant network having an electrolysis plant and a wind energy plant with direct DC coupling;

FIG. 2 shows a plant network according to FIG. 1 having an alternative filter circuit;

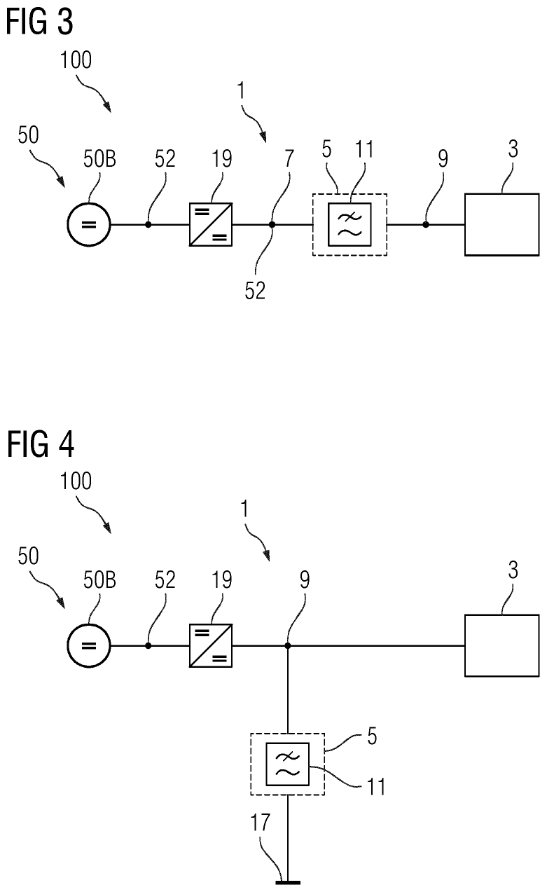

FIG. 3 shows a plant network having an electrolysis plant and a photovoltaic plant with direct DC coupling;

FIG. 4 shows a plant network according to FIG. 3 having an alternative filter circuit.

The same reference signs have the same meaning in the figures.

FIG. 1 illustrates a plant network 100 according to the invention. The plant network 100 comprises an electrolysis plant 1 and a wind energy plant 50A that is connected to the electrolysis plant 1 as a renewable energy plant (RE plant) and a source of green power. The electrolysis plant 1 has an electrolyzer 3 and a circuit arrangement 5 which is electrically connected to the electrolyzer 3. The circuit arrangement 5 is connected to the electrolyzer 3 via the output 9. The circuit arrangement also has an input 7 which can be used to supply a direct current to the electrolysis plant. The input 7 is designed for connection to an external power source, in particular an external DC source. Direct current, so-called direct electrolysis current, is supplied from a DC source via the circuit arrangement 5. The circuit arrangement 5 has an electrical filter device 11 for interference-free and noise-suppressed supply of a high-quality direct current. The filter device 11 is designed in such a way that high-frequency signal components from the power source can be attenuated and suppressed very effectively. To this end, the filter device 11 is in the form of a low-pass filter which has an RC element, that is to say a passive component. Further options for the design of the filter device 11 are a low-pass filter of the 2^{nd} order or a higher order which has an LRC low-pass filter, that is to say an inductance, an ohmic resistor and a capacitance. Providing the circuit arrangement 5 with a filter device 11 in the form of an active filter may also be advantageous. The filter device 11 then has for example an operational amplifier as active component. Problems with ground faults and corresponding disadvantageous instances of coupling high-frequency interference signals into the electrolysis plant 1 are greatly reduced by the filter device 11. This protects the particularly sensitive components of the electrolyzer 3, in particular the plurality of electrolyzer cells, and guarantees a target voltage with a high degree of consistency and quality.

The electrolysis plant 1 furthermore has a rectifier 15, the outside of which is connected to the input 7 of the circuit arrangement 5. The input side of the rectifier 15 is connected to an AC source, in the exemplary embodiment to a wind energy plant 50A that supplies an alternating current. The direct AC connection is carried out via the output 52 of the wind energy plant 50A. By way of the electrical filter device 11 in the circuit arrangement 5, in the case of the direct connection, a direct current that is mostly free of high-frequency signal components can be supplied to the electrolyzer 3 via the filter device 11.

The circuit arrangement 5 is supplied with direct current via the rectifier 15, said circuit arrangement in turn enabling very effective filtering for the direct DC connection by means of the filter device. The electrolyzer 3 is thus supplied with a direct current, the electrolysis current. The electrolyzer 3 may in this case be in the form of a PEM electrolyzer or an alkaline electrolyzer.

The electrolysis plant 1 is directly connected to the wind energy plant 50A in order to be supplied with direct current for the electrolysis process. The connection is carried out via the output 52 of the wind energy plant 50A initially to the rectifier 15 and in FIG. 1 in a series circuit to the circuit arrangement 5 having the filter device which in turn supplies direct electrolysis current to the electrolyzer 3 via the output 9. The wind energy plant 50A first generates an alternating current in the generator. To be able to deliver a direct current to the electrolyzer 3, a rectifier 15 is provided in the electrolysis plant 1 so that the direct connection to the output 52 is carried out on the AC side via said rectifier 15, wherein the rectifier in this case is advantageously an electrical power component of the electrolysis plant 1. However, it is also possible that rectification takes place even before the transfer in the wind energy plant 50A itself.

In order to vary the voltage or the current intensity for the electrolysis, the rectifier 15 is controllable and is in the form of a three-phase rectifier or a B6 bridge rectifier. This has an IGBT, an insulated-gate bipolar transistor, which is not illustrated in any more detail, as a semiconductor component. This is a component which is often used in power electronics since it combines advantages of the bipolar transistor, such as a good on-state behavior, a high reverse voltage and robustness, and the advantages of a field-effect transistor with virtually power-free control. The distinctive advantages of IGBTs are the high voltage and current limits: voltages of up to 6500 V and currents of up to 3600 A with a power of up to a few megawatts predestine IGBTs for use in electrolysis plants. As a result, the IGBT in the rectifier 15 can be ideally used for the operating range of the electrolyzer 3.

Depending on the application, it is also conceivable to use a so-called IGCT in the rectifier 15, that is to say an integrated gate-commutated thyristor. The latter has a reduced wiring complexity, an increase in the maximum pulse frequencies for control and better switching times when connected in series, which is advantageous. The field of use of IGCTs are high-power converters. An individual module typically switches several kiloamperes at a typical reverse voltage of 4500 V.

The circuit arrangement 5 is used to implement very effective interference suppression via the filter device 11. As a result, during operation, high-frequency electrical stray currents are greatly reduced, these being able to couple in via ground loops and adversely affecting the electrolyzer 3 having the very sensitive electrolysis cells, since the ohmic losses due to ground loops can lead to a very disadvantageous voltage drop across the electrolysis cells. The lower the electrical resistance of the ground connection between the components involved, the lower the potential difference. This is conventionally achieved by means of low-resistance cable and plug-in connections or a large cross section of the shields, a lower contact transition resistance and the advantageous galvanic decoupling optionally also provided in addition depending on design. A transformer, that is to say an iron core with coils, which constitutes a further measure for interference suppression and filtering, may also simply be provided in the filter device 11 in order to generally reduce the stray currents with respect to ground, in particular.

It is therefore possible to achieve the desired filter effect in the filter device 11 also using an inductance and designing and adapting the filter device 11 accordingly. In this case, for example a plurality of passive filters for various frequencies or mixed passive and active filter arrangements for the filter device 11 may also be provided in the filter device 11 of the electrolysis plant 1. This can also be done inter alia by using a high-inductance coil/line in series, an RC element (low-pass filter), an LRC-pass filter of the 2^{nd} order, the use of a low-passive filter of a higher order or active filtering.

During operation of the plant network 100, green power is produced in the wind energy plant 50A. The alternating current produced in the generator is converted into a direct current in the rectifier 15. As a result, the renewable energy plant 50—using the example of the wind energy plant 50A—ultimately provides a DC source, with the result that a direct current is directly fed into the input 7 of the electrolysis plant 1 via the output of the rectifier 15 and is initially transferred to the circuit arrangement 5. In the circuit arrangement 5, the filter device 11 carries out filtering, with the result that stray currents are suppressed or avoided.

The output side of the circuit arrangement 5 provides an interference-free or hum-free DC electrolysis voltage at the output 9, which is used to operate the electrolyzer 3 in a stable manner, wherein water is split into hydrogen and oxygen. Ground loops are avoided. The advantageous direct DC connection of the electrolysis plant 1 to the wind energy plant 52A makes possible grid-independent island operation and decentralized generation of green power onshore or offshore depending on application. The proportion of green hydrogen is in this case 100%.

In a further exemplary embodiment of a plant network 100 according to the invention having a wind energy plant 50A, an alternative filter circuit is shown in FIG. 2. In this case, the circuit arrangement 5 is not connected in series with the filter device 11 but the filter function is incorporated by virtue of the circuit arrangement 5 being connected directly to the output side of the rectifier 15 and being conducted with respect to a reference-ground potential 17, in particular ground potential, zero potential or ground. The electrolyzer 3 is then supplied with filtered and interference-suppressed DC voltage of a high quality via the output 9. The mode of operation of the filtered direct connection of the electrolysis plant 1 provided via the circuit arrangement 5 to the wind energy plant 50A is analogous to the plant network 100 described in FIG. 1.

FIG. 3 shows a plant network 100 having an electrolysis plant 1 and a photovoltaic plant 50B in direct DC coupling, a plant concept having a very advantageous DC source for supplying direct current to the electrolysis plant 1. In this case, the renewable energy plant 50 has a photovoltaic plant 50B, having a plurality of PV modules, not illustrated in more detail. The photovoltaic plant 50B may for example be in the form of an extensive and efficient open-area plant—preferably in sunny regions—so that PV powers at a peak of at least 5 MW of electrical power are available for the electrolysis. An analogous plant concept 16 as applied in FIG. 1 and appropriate plant components, that is to say having a circuit arrangement 5 and having an electrolyzer 3 is used for the electrolysis plant 1, wherein the circuit arrangement 5 is arranged in series between the photovoltaic plant 50B and the electrolyzer 3. In this case, the filter device 11 is accordingly integrated into a series circuit and connected upstream of the electrolyzer 3.

To arrive at a desired and advantageous voltage level for connection to the electrolysis plant 1, a DC chopper 19 is connected to the photovoltaic plant 50B in the example of FIG. 3. A DC chopper 19 is also referred to as a DC-DC converter, and so the DC voltage supplied to the input thereof from the photovoltaic plant 50B is converted to a DC voltage with a higher, lower or inverted voltage level. The conversion is performed using a periodically operating electronic switch and one or more energy storage devices. DC choppers 19, also referred to as DC voltage converters, are included in self-commutated power converters, which play a large role in the field of electrical engineering. The inductance (inductive converter) used to buffer-store the energy consists of a coil or a converter transformer.

The output side of the DC chopper 19 connected to the photovoltaic plant 50B is connected to the input 7 of the circuit arrangement 5 at the output 52 such that a direct connection to the electrolysis plant 1 and a supply of PV direct current is achieved, wherein the stray currents are effectively suppressed by the filter device 11, in particular the low-pass filter. In this case, the output 52 of the DC chopper forms a DC source of the photovoltaic plant 52B at a predefinable DC voltage level. The electrolysis plant 1 is connected directly to the output 52 of the photovoltaic plant. It is also conceivable and possible that the DC chopper 19 is a component of the power electronics system of the electrolysis plant 1 itself and is accordingly adapted to and preconfigured for the PV voltage level.

In another exemplary embodiment of a plant network 100 according to the invention having a photovoltaic plant 52B, FIG. 4 shows an alternative filter circuit. In this case, the circuit arrangement 5 is not connected in series with filter device 11 but the filter function is incorporated and ensured by virtue of the output side of the circuit arrangement 5 being connected directly to the DC chopper 19 and being carried to a reference-ground potential 17, in particular ground potential, zero potential or ground. The electrolyzer 3 is then supplied with high-quality filtered and interference-suppressed DC voltage via the output 9.

The mode of operation of the direct connection of the electrolysis plant 1 to the photovoltaic plant 50B, provided by the circuit arrangement 5 and free of interference via the filter device 11, is analogous to the plant network 100 described in FIG. 3.

The invention specifies an electrolysis plant 1 by means of which a direct current or an alternating current can be fed from a renewable source directly and without interference into the electrolysis plant 1 such that 100% green hydrogen can be produced in the electrolysis process. This is particularly advantageously carried out in the described plant network 100 comprising an electrolysis plant 1 and a renewable energy plant 50, which are electrically connected to one another and physically located in close proximity and advantageously integrated so as to form a plant network 100.

The circuit arrangement 5 having the filter device 11 in this case enables a particularly simple and effective direct DC connection. This appears to be advantageous in terms of cost compared to alternative solution approaches using transformers that can be used to implement the principle of galvanic isolation or decoupling. For the case where a complex and expensive transformer system is not available or is not applicable due to local conditions and restrictions based on plant technology, it is preferable to filter using the electrical filter device 11 on the DC side according to the invention, where high-frequency signal components are attenuated. This can also be carried out inter alia by using a high-inductance coil/line in series, an RC element (low-pass filter), an LRC low-pass filter of the 2^{nd} order, the use of a low-pass filter of a higher order or active filtering. The filtering in the circuit arrangement 5 having the filter device 11 is carried out in this case either directly at the rectifier 15 or between the rectifier and the electrolyzer 3. Filtering at a ground line, for example in a star grounding system in the generator system, or at or in the rectifier 15 is also possible. Filtering at a defined ground connection in the electrolysis system, for example centrally in a module series, where the potential is close to the reference-ground potential 17 or ground potential anyway, is also possible.

The application of the electrolysis plant 1 of the invention both for PEM hydrogen electrolysis plants and for alkaline electrolysis plants in a plant network 100 having a renewable energy plant 50 is particularly advantageous. In this case, the problem of suppressing high-frequency ground currents in the case of a direct connection, in particular a direct DC connection, has been identified and has been very advantageously solved.

14. (canceled)

15. An electrolysis plant, comprising:
an electrolyzer; and
a circuit arrangement having an input for connection to a power source and an output connected to the electrolyzer;
said circuit arrangement having an electrical filter device configured for attenuating high-frequency signal components.

16. The electrolysis plant according to claim 15, wherein the high-frequency signal components to be attenuated originate in the power source.

17. The electrolysis plant according to claim 15, wherein said filter device has a low-pass filter.

18. The electrolysis plant according to claim 15, wherein said filter device is a low-pass filter of the 1st order which has an RC element.

19. The electrolysis plant according to claim 15, wherein said filter device has an inductance configured to attenuate the high frequency components.

20. The electrolysis plant according to claim 15, wherein said filter device is a low-pass filter of the 2nd order or a higher order which has at least one LRC low-pass filter.

21. The electrolysis plant according to claim 15, wherein said filter device is an active filter and includes an operational amplifier.

22. The electrolysis plant according to claim 15, further comprising a rectifier having an output connected to said input of said circuit arrangement and an input to be connected to an external AC source and being configured to enable a direct current without high-frequency signal components to be supplied to said electrolyzer via said filter device.

23. The electrolysis plant according to claim 22, wherein said rectifier is a controllable rectifier and/or a three-phase rectifier.

24. The electrolysis plant according to claim 23, wherein said rectifier is a B6 bridge rectifier.

25. The electrolysis plant according to claim 22, wherein said filter device is connected in series between said rectifier and said electrolyzer.

26. The electrolysis plant according to claim 22, wherein said filter device is connected to said rectifier and is connected to a reference potential.

27. The electrolysis plant according to claim 26, wherein said filter device is connected to ground potential.

28. A plant network, comprising:
an electrolysis plant according to claim 15; and
a renewable energy plant forming a power source having an output;
said electrolysis plant being connected to said output of said renewable energy plant.

29. The plant network according to claim 28, wherein said the renewable energy plant comprises a wind energy plant.

30. A plant network, comprising:
an electrolysis plant according to claim 15; and
a renewable energy plant, said renewable energy plant having a photovoltaic plant forming a DC source with an output;
said electrolysis plant being connected to said output of said photovoltaic plant.

31. The plant network according to claim 30, wherein said photovoltaic plant has a DC chopper forming said output.
